(19) United States
(12) Patent Application Publication
(10) Pub. No.: US 2015/0241219 A1
(43) Pub. Date: Aug. 27, 2015

(54) Method and Apparatus for Providing a Navigation Route Having Multiple Associated Points of Interest

(71) Applicant: Ford Global Technologies, LLC, Dearborn, MI (US)

(72) Inventors: Nello Joseph Santori, Canton, MI (US); Heath Williams, South Lyon, MI (US); Jeffrey Monticello, Livonia, MI (US); Nicholas Thorne, Dearborn, MI (US); Kevin F. Militello, South Lyon, MI (US); William Lawrence Frantz, Detroit, MI (US); Kevin Marx, Livonia, MI (US)

(73) Assignee: Ford Global Technologies, LLC, Dearborn, MI (US)

(21) Appl. No.: 14/189,037

(22) Filed: Feb. 25, 2014

(51) Int. Cl. G01C 21/00

(52) U.S. Cl. CPC G01C 21/00

(57) ABSTRACT

A system includes a processor configured to access a map, including pre-designated destinations, each destination having a clue associated therewith. The processor is also configured to provide the clue associated with a first destination. The processor is further configured to track the progress of a user towards the first destination using GPS coordinates. Also, the processor is configured to provide a clue associated with a next destination, once the user has reached the first destination. Further, the processor is configured to repeat map access, clue provision, and tracking until the user has reached a pre-designated final destination.

### TECHNICAL FIELD

The illustrative embodiments generally relate to a method and apparatus for providing a navigation route having multiple associated points of interest.

### BACKGROUND

In-vehicle navigation systems allow users to identify, locate and receive routes to points of interest, destinations and other geographic features. By inputting an address or a location name (e.g., the Statue of Liberty), a program within the navigation system can obtain coordinates associated with a Global Positioning System (GPS). Using a network of existing roads stored in a database, the program can plan a route from a present location to the destination coordinates. Typically, the user will know the particular destination address or name to which the vehicle is routed, so that the system can be informed of the desired destination.

U.S. Patent Application 2010/0131199 generally relates to a GPS navigation code device having GPS features and easy address retrieval means built in, enabling a driver to retrieve and request directions to an address without taking his eyes off the road. The user pre-programs the GPS navigation code device with a plurality of addressees or points of interest and assigns unique navigation codes for each. The navigation code is entered using keyboard or recorded speech pattern. The processor in the GPS navigation code device records address, navigation code and speech pattern in three linked databases. While driving, the user presses a special address search mode key and inputs the unique navigation code by keyboard or speech pattern. The GPS navigation code device displays the address and the user accepts the displayed address by pressing special key. The GPS navigation code device then calculates and displays directions to the address, and provides additional guidance by speech on a turn-by-turn basis.

U.S. Pat. No. 5,938,721 generally relates to a task description being stored in a database accessible by a mobile computer system. The mobile computer system receives positioning information corresponding to its geographic location and indexes the database based on the positioning information when the information indicates that the mobile computer system is in a geographic location that facilitates completion of a task associated with the task description. The database may be resident in the mobile computer system or accessible in other ways, for example, via the Internet. The task description preferably includes a geocode which corresponds to the geographic location at which completion of the task may be facilitated. The task description may also include textual, voice or other message which can be displayed and/or played back to a user. The positioning information may be obtained from a GPS satellite, a GLONASS satellite or a pseudolite. The mobile computer system may be a portable unit, such as a PDA, or integrated within a vehicle

### SUMMARY

In a first illustrative embodiment, a system includes a processor configured to access a map, including pre-designated destinations, each destination having a clue associated therewith. The processor is also configured to provide the clue associated with a first destination. The processor is further configured to track the progress of a user towards the first destination using GPS coordinates. Also, the processor is configured to provide a clue associated with a next destination, once the user has reached the first destination. Further, the processor is configured to repeat map access, clue provision, and tracking until the user has reached a pre-designated final destination.

In a second illustrative embodiment, a system includes a processor configured to receive a route-creation request, including multiple destinations. The processor is also configured to receive selection the multiple destinations. The processor is further configured to associate user-input information with each destination. Also, the processor is configured to receive an ordering of the destinations and create a route-data-package, including the multiple destinations, the ordering, the associated user-input information, instructions instructing conditions upon which the user-input information is to be presented to a requesting party and instructions instructing when each of the multiple destinations is to be presented to a requesting party.

In a third illustrative embodiment, a computer-implemented method includes receiving a route-creation request, including multiple destinations. The method also includes receiving selection the multiple destinations. Further, the method includes associating user-input information with each destination. The method also includes receiving an ordering of the destinations and creating a route-data-package, including the multiple destinations, the ordering, the associated user-input information, instructions instructing conditions upon which the user-input information is to be presented to a requesting party and instructions instructing when each of the multiple destinations is to be presented to a requesting party.

### BRIEF DESCRIPTION OF THE DRAWINGS

FIG. 1 shows an illustrative vehicle computing system;

FIG. 2A shows an illustrative scavenger hunt creation process;

FIG. 2B shows a second illustrative scavenger hunt creation process;

FIG. 3 shows an illustrative process for clue creation;

FIG. 4 shows an illustrative scavenger hunt access process;

FIG. 5 shows an illustrative scavenger hunt participation process; and

FIG. 6 shows an illustrative scavenger hunt reporting process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

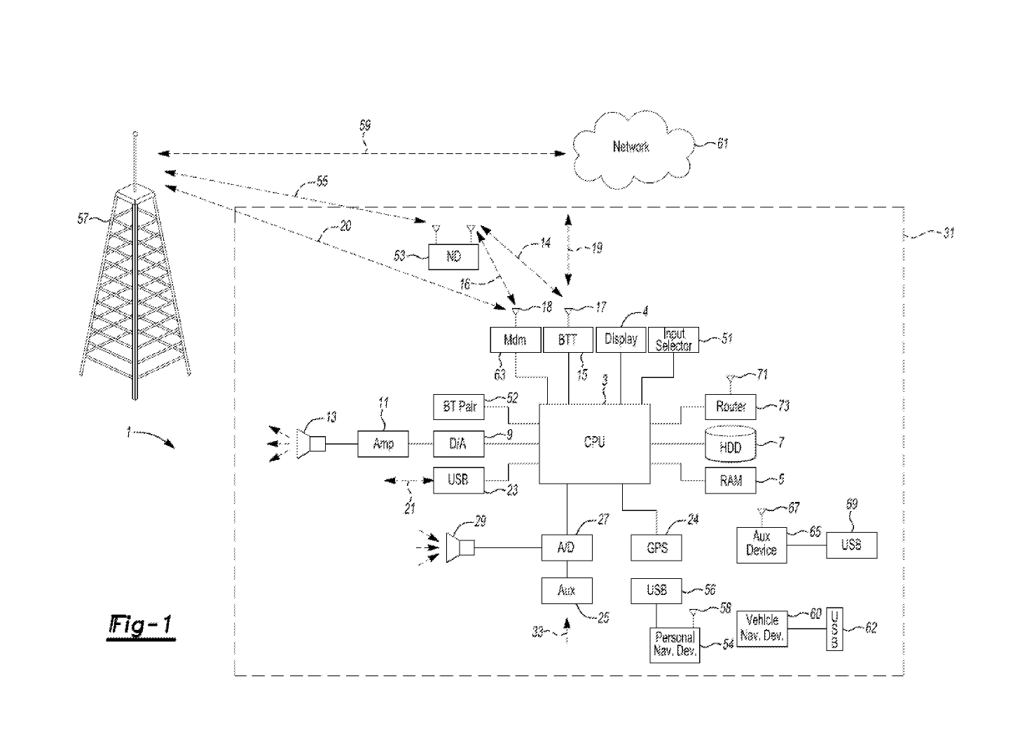

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

Scavenger hunts have always been a fun pastime encouraging a group of people to participate in a planned activity, exploring and looking for clues and items/locations designated by the event planner. When combined with automobiles, these hunts have been called road rallies, and participants use vehicles to travel over a wider range to discover the clues and/or destinations. Through the use of vehicle-based navigation systems, and/or navigation applications on mobile devices, the illustrative embodiments provide for a centralized planning, distribution and participation in a new form of road rally.

An event creator can select a number of points of interest on a map, associate clues with those points of interest, designate conditions for clue distribution, and disseminate the clues to participants. Further, since communication with participants is two-way, the participants, or their devices, can report back to a central computer so that all participants and/or the event planner can track the progress of each participating person or group. Participants can also upload evidence that various goals have been met, or that particular objects have been found/identified.

These road rallies can be useful for introducing a group of people to a new area, providing an interactive tour or group-participation game, providing a promotional event or a contest or just for general enjoyment. They also encourage people to drive and use their vehicles, encouraging recreational use of a vehicle, as opposed to the common pure functional use that many people reserve their vehicles for (e.g., going to work, going to the store, etc.).

To begin a road rally, in the illustrative embodiments, an event planning user will first create the rally. In at least one example, this includes a plurality of destinations and clues to those destinations. The destinations and/or clues can have locations, roads, etc. associated therewith, to aid the participants in knowing whether or not they are on the right path or at a correct location.

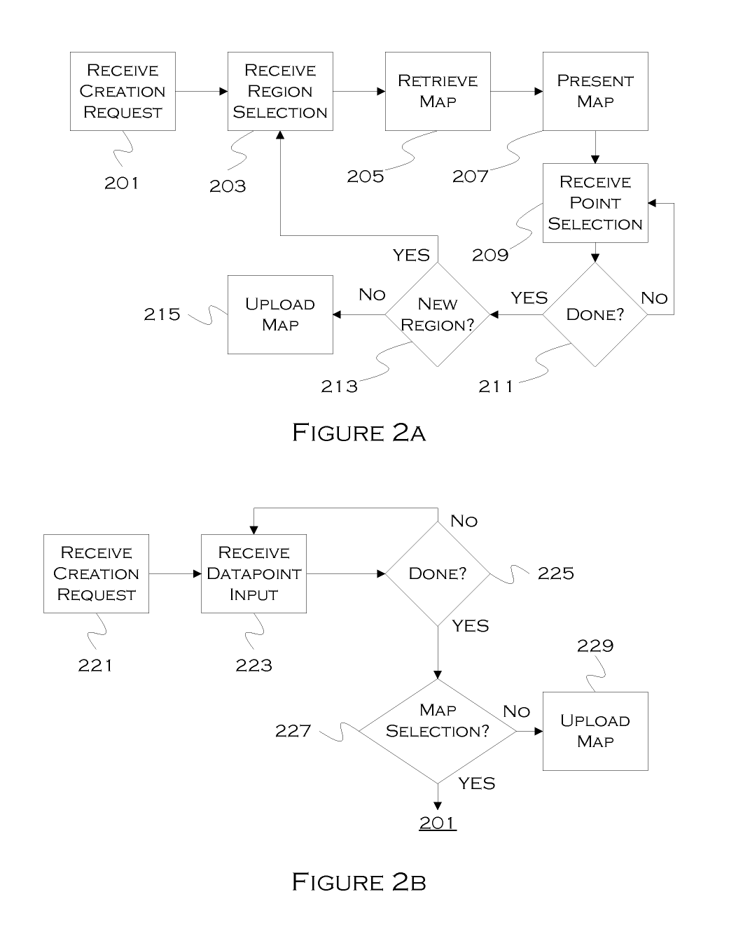

FIG. 2A shows an illustrative scavenger hunt creation process. In this illustrative example, the process receives a request for road rally creation 201. The process can run on a local machine, and can upload the road rally to a central location for distribution after created, or the creation process can run on a remote server and be accessed by the creator.

In this example, the creator selects a region in which the rally exists 203. This can be a city, a locality, or any other suitable geographic region. Selection can be made, for example, by zooming in on a larger map or typing in a designated region or city 205. Zooming in to a location may result in a map showing individual roads that provide for point of interest selection based on intersections, for example 207. In another example, an address may be provided, and the region may show a map of the locality around the address, so that the user can ensure that a correct location was input. Other, previously selected points may also be shown on the map, if in proximity to the current point, so that the user can ensure that the destinations are not too close together or too far apart.

If the user has not input an address, the user may select a point on the displayed may (using a mouse, touch-interface, etc.) for a destination in the road rally 209. A location name (e.g., building or business name) or address may be shown as associated with the selected point. Since a road rally may have multiple destinations within a city or region, the user may also select additional points, or input additional addresses, shown on the same map. Until point selection/input is completed 211, the selection process will continue. Once all suitable points have been selected, the process will provide the user an opportunity to select a new region 213. If a new region is selected, the process can continue for that reason, otherwise, the process (if remote from the central server, for example), will upload a map of all the points 215.

The user can also use the selection process to order the points, in an order which it is intended they are to be viewed. The default ordering may be, for example, to order the points in the manner which they are designated. But, the user could also change this ordering if desired, or designate a different ordering (e.g., start at a final destination, work backwards towards a starting point as points are selected).

FIG. 2B shows a second illustrative scavenger hunt creation process. In this example the creation process includes an option for input using an address or location name. Again, the process is initiated 221 and an option is provided for the user to input a location name or address 223. The user can continue entering names or addresses as long as they are known to the user 225. Then, once all addresses and/or names have been entered, the user can be given an option to input map selection locations as well 227. Once both selection types have been completed, the process can upload the map 229.

If the ordering defaults to ordering based on input ordering, it is also possible to fluctuate between address/name input and map-selection input as suitable until the entire route has been completed. Or, as previously noted, the user may re-order the map points as suitable, once point input has been completed.

In addition to a series of locations, most road rallies and or scavenger hunts have some form of clues associated therewith. These clues lead the user to each destination, and then a new clue to a new destination can be provided. Multiple clues can be associated with each location, and can be provided as needed or desired. The clues can be used to “score” the event, for example, by providing scoring based on number of clues used to find a location. In another example, both clues and information about the location can be provided, or the clues can simply be a name of a next location to guide a user through the route.

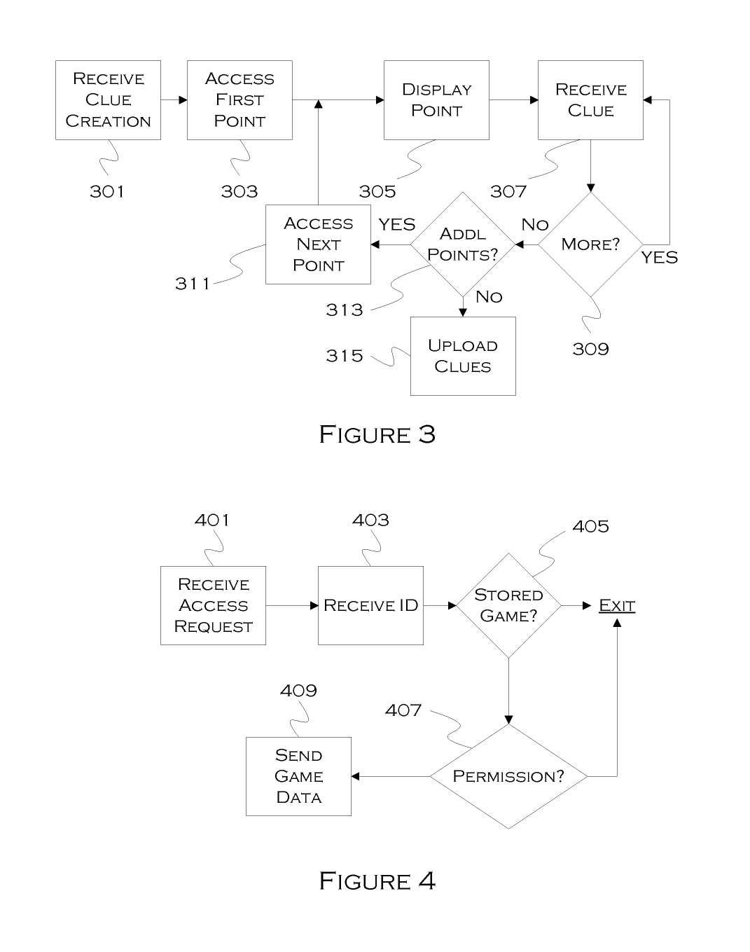

FIG. 3 shows an illustrative process for clue creation. A clue creation action is first initiated 301, allowing the user to access the clue/information creation process. The user can access a first point in a created road rally 303, and the point can be displayed for the user 305. Showing the point on a map, for example, can help the user ensure that the proper point is selected, and can also provide context information for the user if the clues are to relate to a surrounding area.

While clue creation follows point selection/creation in this illustrative example, the processes could also be intertwined, such that clues are created as each point is selected/designated. Once the point has been selected and displayed, if desired, the process will receive input of the first clue 307. The user can create the clue, and then, if there are additional clues to be associated with the point 309, create the additional clues.

If additional points of interest remain 309, the user can access each next point 311 and proceed with clue creation for the additional points. This can continue until all clues and points have been input and associated. Scoring values can also be assigned to the clues. For example, without limitation, each un-used clue can be worth a certain number of points. Or, easier or more difficult clues can have different points associated therewith. One clue might even be the actual address, in case the user cannot solve the puzzle created by the other clue(s). Once all clues have been created and input, the process can upload the clues/points to create the finalized road rally 315.

Once the road rally has been created, the creator may wish to provide the rally for participants to download and utilize. The rally may be stored at a central server, and users can use an application running on a mobile device or in a vehicle to access the central server. This can give the user access to the created road rally, and provide for download/access to the clues and designated points. The user's progress can also be uploaded to the server and associated with the particular rally, so that the creator and other participants can track the progress of each user.

FIG. 4 shows an illustrative scavenger hunt access process. In this illustrative example, the central server receives an access request for obtaining a particular road rally 401. The user can provide both user identification and/or a road rally identification 403. This information can be used to authenticate the user to ensure they are permitted to access the road rally. In some instances, the user may be authenticated, for example, based on the device (vehicle, phone, etc.) from which the access was made.

If there is a stored game, saved for the user ID and/or the game ID provided 405, the process can determine if the user/device has permission to access the identified game 407. If the user has permission to access the saved game, the process will send any needed road rally data to the device/user 409 so that the user can engage in the road rally. The road rally may begin at a designated time, may begin when all users are logged in, or may be ongoing and various scores can be compared based on various completion successes.

Road rallies can also be used to promote events or provide tours. For example, if a city was hosting the Olympics, it may be desirable to provide visitors with a tour of the various venues before the events take place. This could actually aid the city by reducing lost and confused tourists during the ongoing games. A foot or vehicle based (or combination) rally could include all the various venues. The process could be downloaded by visitors and used to explore the city and venues in advance of the actual ceremonies. This is just one example of how the road rally can be used in a manner other than just for pure entertainment purposes.

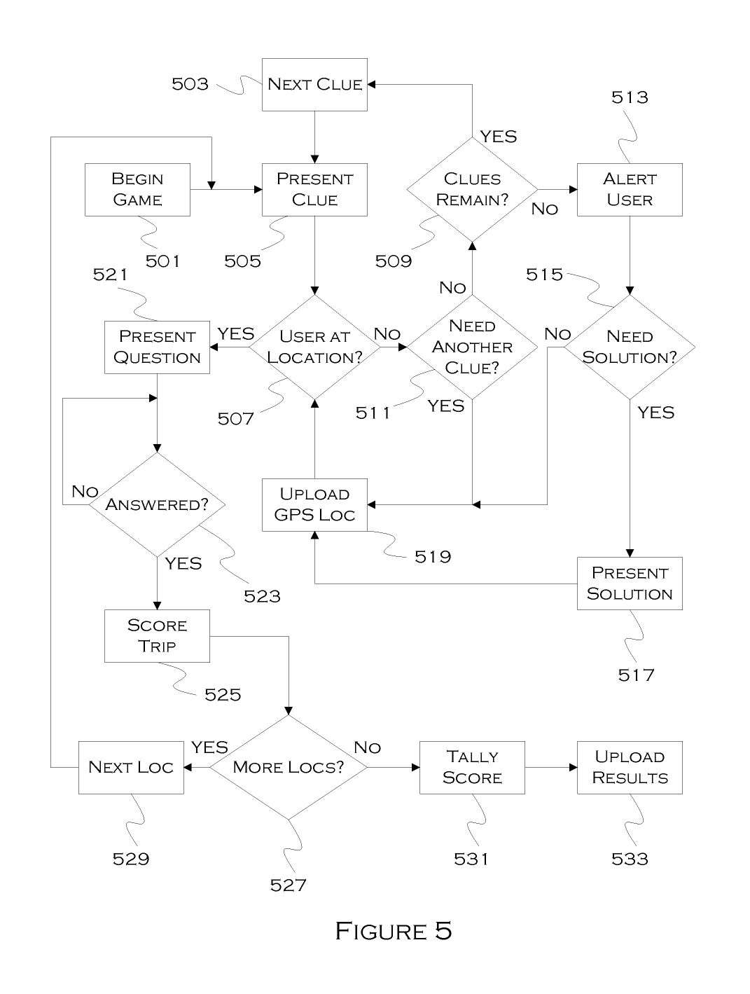

FIG. 5 shows an illustrative scavenger hunt participation process. In this illustrative example, a user has elected to begin a game, or the game has reached a starting point (time, participants, etc.) 501. In association with the game beginning, the process may broadcast a notice that the game is to begin, or, for example, each application providing the game may execute a game-start on the respective device/vehicle on which the application is running.

In conjunction with the beginning of the road rally, the user may be presented with a first clue 505. In some cases, this may merely be the location of the next destination in the rally. In other cases, the process may provide the user with a clue to the location, such as a riddle, or a nearby monument, or other suitable information. The user can process the clue and begin travel to the destination. If the user has not reached the destination, the process may determine if another clue is needed 511. Based on the user's current location, speed, traffic, etc., and the destination, the process may wait some suitable period of time before providing a second clue.

Also, the provision of a second clue may be based on whether or not the user is generally headed in the right direction. As long as the user is making progress, receipt of a new clue may be left to the discretion of the user. If the user heads in the wrong direction, or if the destination progress is not moving fast enough, the user may be provided with another clue 503. Users can also be provided with other clues when reaching a destination on the way to the main destination.

For example, if there were three “sub destinations” around a main destination, when the user reached a pre-specified zone around one of the sub-destinations, the process could provide an additional clue, letting the user know that they were traveling in the right direction.

Zones can be specified around both destinations and other points along the way. If the zone crosses one or more roads, then vehicles traveling along those roads could pass through a “clue zone” or “destination zone.” Various actions could be taken based on which zone is breached by the vehicle.

If another clue is needed, the process may determine if any clues remain 509. If no clues remain, the process may alert the user 513. The user may be given the option to have the clues solved, if desired 515. This will result in the presentation of a solution to the user, if selected 517. Otherwise, the user's current GPS location will be uploaded to the central server 519, so that progress can be tracked. Until the user reaches the designated location, the option for additional clues may persist, as well as the option to have the clues solved and a destination presented.

Once the user reaches a physical destination, in this example, a question may be presented relating to the destination 521. This can assist in ensuring that the user has actually found the specified location, and is not merely near the location. It can also add a further aspect of fun to the game, by allowing a user to search and/or learn information at the specified destination.

Until the user has answered the question 523 (or, for example, if a suitable time has passed and no answer has been given), the process will wait for the user to discover the answer. Answers can also come in the form of a photograph or other information demonstrating that the user has potentially found the destination. In another embodiment, once an answer is given, the road rally will progress, and answers can be checked for correctness at a later point.

In this example, scoring is included with the process, so the trip/leg of the trip is scored 525. This can be based on success in answering the questions, time used for the trip/leg, number of clues used, or any other suitable manner. Then, if more locations remain 527, the process can repeat for a next location 529. Once process has completed for all the locations in the road rally, the process can tally the score 531 for the team and upload any results to the server, if needed 533.

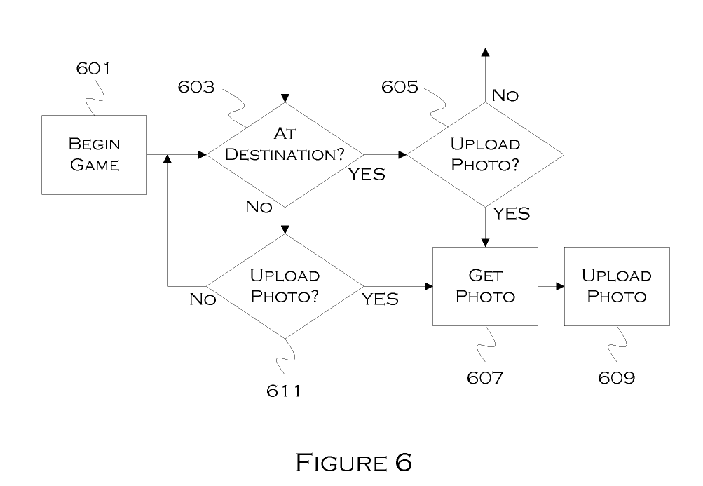

FIG. 6 shows an illustrative scavenger hunt reporting process. In some road rallies, the user may want to include some visual evidence (e.g., a picture), that the each destination has been reached. These images may provide entertainment for other participants, and can be used to memorialize the rally as well.

In a road rally including pictures, the game begins and the process waits until a destination is reached 603. At any point before a destination is reached, the process may allow for uploading of other pictures 611. These could be, for example, pictures of participants having fun, interesting sights along the way to the rally, or any other suitable pictures.

Once the destination has been reached, the user is permitted to upload a destination photo 605. The photo can be taken 607 with a phone associated with the application, or a vehicle camera, or with any other suitable digital device. The user can upload the photograph 609, once taken.

Through use of the illustrative embodiments, many fun road rallies for varied purposes can be created. Vehicle use and area exploration can be encouraged. People can participate in fun games with friends. Tours can be provided and promotional events can be conducted. By making the process into a game, as opposed to merely providing a map to all points, participation may be made more interesting. Information about destinations can also be provided upon arrival, so that a user could learn about each destination as it was discovered.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a processor configured to:
access a map, including a pre-designated destination having a plurality of clues associated therewith, at least a second clue having a geographic boundary, around the pre-designated destination, associated therewith;
provide a first clue associated with the destination;
determine if a user location falls within the geographic boundary; and
provide the second clue once the user location falls within the geographic boundary.

2. (canceled)

3. (canceled)

4. (canceled)

5. (canceled)

6. The system of claim 1, wherein the processor is further configured to provide the second clue once the user location falls within the geographic boundary and a predetermined time limit has passed since provision of the first clue.

7. (canceled)

8. The system of claim 1, wherein the processor is configured to provide scoring for a trip to the destination, based at least in part on a number of the plurality of clues associated with the destination used to reach the destination.

9. (canceled)

10-20. (canceled)
